(19) United States
(12) Patent Application Publication
(10) Pub. No.: US 2009/0119121 A1
(43) Pub. Date: May 7, 2009

(54) Peer-to-peer service providing system and method for preventing contents from being illegally distributed

(75) Inventors: Han Kang, Seoul (KR); Dae-Gull Ryu, Seoul (KR); Min-Gwan Bae, Gunpo-si (KR)

Correspondence Address: REED SMITH LLP, Suite 1400, 3110 Fairview Park Drive, Falls Church, VA, 22042, US

(73) Assignee: MWSTORY Co., Ltd.

(21) Appl. No.: 11/979,411

(22) Filed: Nov. 2, 2007

(51) Int. Cl. G06Q 99/00

(52) U.S. Cl. 705/1

(57) ABSTRACT

A peer-to-peer (P2P) service providing system and method for preventing contents from being illegally distributed are disclosed. An electronic tag is assigned to digital contents after generating the contents. Information regarding the electronic tag is provided in response to a content request. A determination is made as to whether a fee to share corresponding contents has been paid using the electronic tag information, and the corresponding contents are provided. Illegal content distribution through the Internet (particularly, a P2P system) can be prevented.

### BACKGROUND OF THE INVENTION

1. Field of the Invention

The present invention relates to a system and method for providing a peer-to-peer (P2P) service, and more particularly to a P2P service providing system and method for preventing contents from being illegally distributed.

2. Description of the Related Art

In general, users desiring to receive information on the Internet employ a client/server method and system in which required information is received from an information providing server after they have accessed the information providing server via the Internet. In accordance with the client/server method, when multiple clients access the server in the client/server system, there is a problem in that a system processing capacity, a network bandwidth, or the like may be inadequate. For this reason, the users may not smoothly receive a service.

To address this problem, a peer-to-peer service (hereinafter, referred to as “P2P service”) has been proposed in which persons having access by a predetermined program can directly share their information without a specific server for providing information.

Since the term “peer” may stand for a friend or colleague, the P2P service means a service that enables various information and files to be shared by directly accessing the computers of different users via the Internet.

FIGS. 1A and 1B are views illustrating configurations of conventional P2P service providing systems.

FIG. 1A shows an example of establishing a direct connection between clients without a special server system for a P2P service, and FIG. 1B shows an example of connecting clients via a special server system for a P2P service.

Referring to FIG. 1A, each of clients 10a, 20a, and 30a mutually shares in advance individual information of addresses (for example, Internet protocol (IP) addresses) or the like. Then, the clients 10a, 20a, and 30a are mutually connected using the individual information. Required information is retrieved from the clients connected in this manner and the retrieved information is used.

Referring to FIG. 1B, clients 10b, 20b, and 30b are mutually connected to each other via a P2P server 40 connected to the Internet 50. By receiving help from the P2P server 40, access and retrieval between the clients may be achieved. However, after the access and retrieval, information may be directly shared and exchanged between individuals as in an example shown in FIG. 1A.

The above-described P2P system is characterized in that the users not only may comprehensively retrieve databases retained by individuals and companies as well as websites, but also may directly copy corresponding information to their own computers.

FIG. 2 is a view illustrating a route in which contents are illegally distributed in the P2P service providing system. Referring to FIG. 2, a plurality of personal computers (PCs) 11 to 20 are mutually connected to each other in the P2P system with the P2P method. When specific contents are stored in the PC 11 among the PCs 11 to 20, the other PCs 12 to 20 connected to the PC 11 can easily receive the corresponding contents from the PC 11 as shown in FIG. 2. This is achieved by 1:1 communication between the PCs. In this case, the communication between individuals may not be monitored in detail.

Recently, websites or programs for providing a shared web service of the P2P method have been actively developed and supplied on a communication network (for example, the Internet or the like). However, various copyrighted works are being illegally and freely copied and exchanged in a very simple and convenient method through a shared web without authorization of owners of copyright. Accordingly, the profitability of content businesses is significantly lowered. Moreover, there is a problem in that creative desires are destroyed due to the reduced number of copyrighted works and therefore related industries are significantly damaged.

### SUMMARY OF THE INVENTION

The invention has been made to solve at least the above problems and an object of the invention is to provide a P2P service providing system and method for protecting the copyright of digital contents by preventing the contents from being illegally distributed via the Internet.

Moreover, another object of the invention is to provide a P2P service providing system and method for protecting the copyright of digital contents by checking a right to share the digital contents whenever a request for sharing the digital contents is made.

Moreover, a further object of the invention is to provide a P2P service providing system and method for developing related industries to produce and distribute digital contents by protecting the copyright thereof.

In accordance with an aspect of the invention, there is provided a P2P service providing method for preventing contents from being illegally distributed, comprising the steps of: assigning an electronic tag to digital contents after generating the contents; providing information regarding the electronic tag in response to a content request; determining whether a fee to share corresponding contents has been paid using the electronic tag information; and providing the corresponding contents.

Preferably, the method further comprises a step of paying a predetermined commission from a producer to a supplier of the contents when the producer and the supplier are different.

According to another aspect of the invention, there is provided a P2P service providing system for preventing contents from being illegally distributed, comprising: a content supplier terminal for assigning electronic tags to contents on a content basis and sending corresponding contents upon determining that a fee to share the corresponding contents has been paid after sending a corresponding electronic tag when the contents are requested; and a content consumer terminal for providing a corresponding content supplier terminal with information indicating whether the fee to share the requested contents has been paid using the electronic tag transferred from the content supplier terminal after retrieving the corresponding content supplier terminal in response to an external content request.

Preferably, the system further comprises a content producer terminal for producing contents in response to a request from a content producer, wherein the content supplier terminal receives the generated contents from the content producer terminal and assigns an electronic tag to the contents.

Preferably, the system further comprises a content producer terminal for producing contents in response to a request from a content producer and assigning an electronic tag to the contents, wherein the content supplier terminal receives and stores the contents to which the electronic tag is assigned from the content producer terminal.

Preferably, the system further comprises a P2P server for managing network information and content providing information regarding the content consumer terminal and content supplier terminals connected in the P2P system with the P2P method, the content consumer terminal and the content supplier terminals being connected through the P2P server.

Preferably, the electronic tag includes a unique content identifier; content producer information; fee information for using the contents; and payment information for paying the fee.

Preferably, the producer information includes information regarding a connection to the producer having produced the contents, the fee information includes at least one of e-money information and point information, and the payment information includes payment account information for paying the fee.

### BRIEF DESCRIPTION OF THE DRAWINGS

The above and other objects, features, and advantages of the invention will be more apparent from the following description taken in conjunction with the accompanying drawings, in which:

FIGS. 1A and 1B are views illustrating configurations of conventional P2P service providing systems;

FIG. 2 is a view illustrating a route in which contents are illegally distributed in the P2P service providing system;

FIG. 3 is a process flowchart illustrating a method for providing a P2P service according to an exemplary embodiment of the present invention;

FIG. 4 is a view illustrating a configuration example of an electronic tag added to contents according to an exemplary embodiment of the present invention;

FIG. 5 is a view illustrating a procedure for providing contents in a P2P service providing system according to a first embodiment of the present invention;

FIG. 6 is a view illustrating a procedure for providing contents in a P2P service providing system according to a second embodiment of the present invention;

FIG. 7 is a view illustrating a procedure for providing contents in a P2P service providing system according to a third embodiment of the present invention; and

FIG. 8 is a view illustrating a procedure for providing contents in a P2P service providing system according to a fourth embodiment of the present invention.

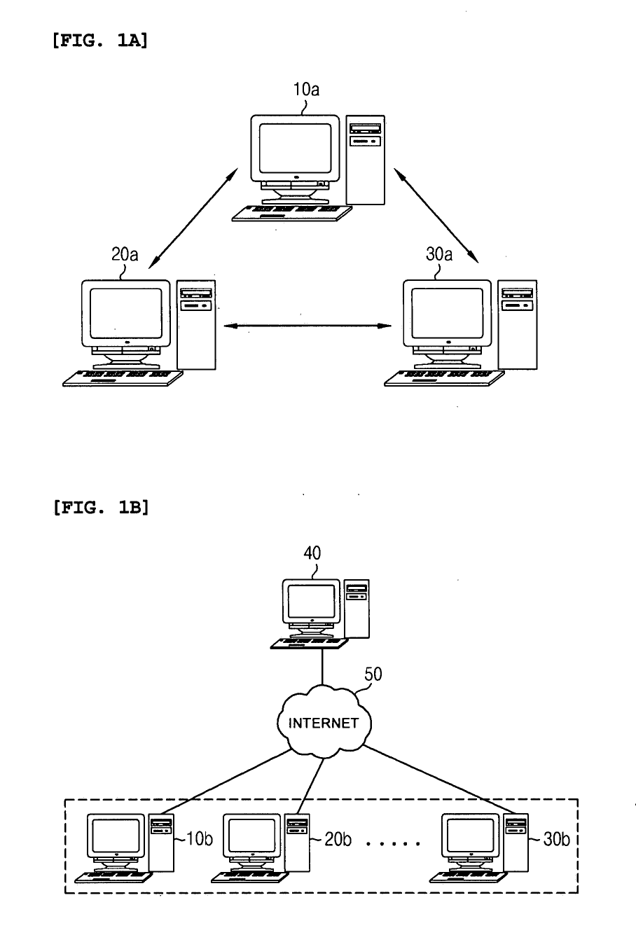

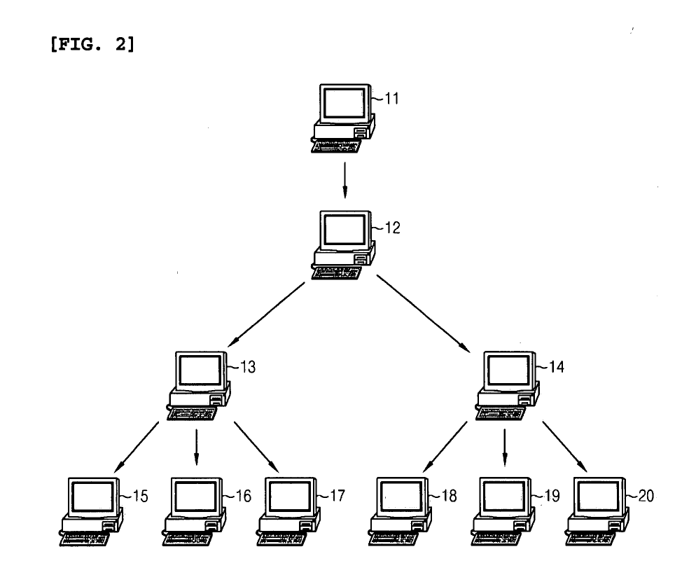

### DESCRIPTION OF EXEMPLARY EMBODIMENTS

Exemplary embodiments of the present invention will be described in detail herein below with reference to the accompanying drawings. In the following description, detailed descriptions of functions and configurations incorporated herein that are well known to those skilled in the art are omitted for clarity and conciseness.

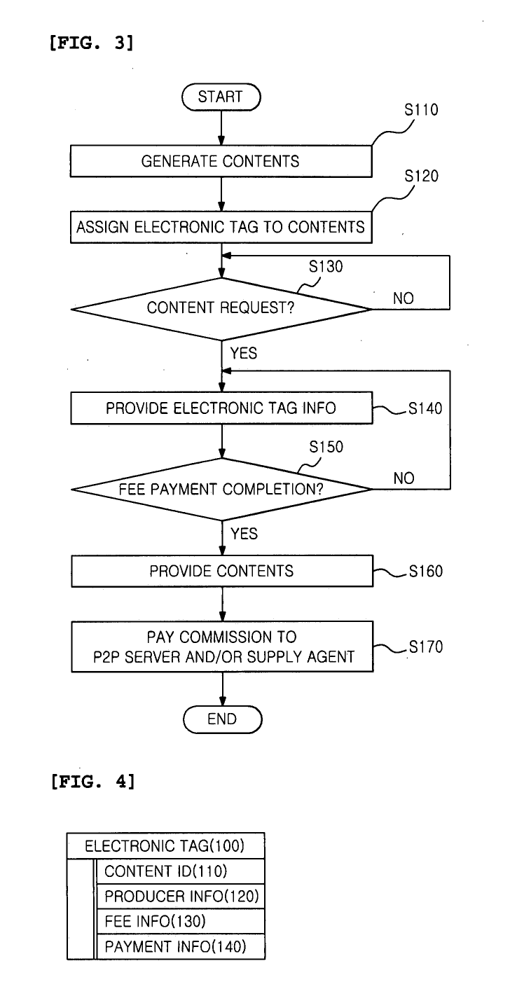

FIG. 3 is a process flowchart illustrating a method for providing a P2P service according to an exemplary embodiment of the present invention. Specifically, FIG. 3 is the process flowchart illustrating the P2P service providing method at the side of a content supplier.

Referring to FIG. 3, the P2P service providing method according to the exemplary embodiment of the present invention is as follows. First, a content producer generates contents (S110) and then assigns an electronic tag to the contents (S120). At this time, it is preferable that a corresponding content producer or supplier generates and assigns the electronic tag. Furthermore, it is preferable that the electronic tag includes producer information and fee payment information of the corresponding contents. This is used to prepay a fee to use the corresponding contents before the contents are transferred in response to a corresponding content request. Specific information included in the electronic tag will be described with reference to FIG. 4.

When the contents are completely generated through steps S110 and S120, the corresponding content supplier (or producer) provides electronic tag information of the corresponding contents in response to a corresponding content request of S130 (S140). That is, the electronic tag information of the corresponding contents is transferred to a corresponding content requestor.

After checking that the requestor has paid the fee (S150), the corresponding contents are provided to the requestor (S160). For this, it is preferable that the requester transfers resulting information to the supplier (or producer) after prepaying the fee to use the contents by referencing the electronic tag information of the contents.

When there are a content providing agent and/or a P2P server for relaying a connection to the content requester, the content supplier (or producer) pays a predetermined commission to the P2P server and/or the content providing agent with respect to the contents whose fee has been paid (S170).

In the invention as described above, fee payment information for the corresponding contents is provided whenever a content transmission request is made upon distributing P2P contents, and the contents are prevented from being illegally distributed by providing the contents after determining that the fee has been paid.

FIG. 4 is a view illustrating a configuration example of an electronic tag added to contents according to an exemplary embodiment of the present invention. Referring to FIG. 4, an electronic tag 100 includes a content identifier (ID) field 110, a producer information field 120, a fee information field 130, and a payment information field 140.

At this time, it is preferable that the producer information field 120 includes connection information (for example, IP address information or the like) mapped to a producer having produced corresponding contents, the fee information field 130 includes fee information for use of the corresponding contents (for example, e-money, points, or the like), and the payment information field 140 includes information for paying the corresponding fee (for example, payment account information or the like).

It is preferable that the electronic tag as illustrated in FIG. 4 is provided to a corresponding content requester in step S140 of FIG. 3. On the other hand, it is preferable that the requester pays the fee for the corresponding contents by referencing the electronic tag.

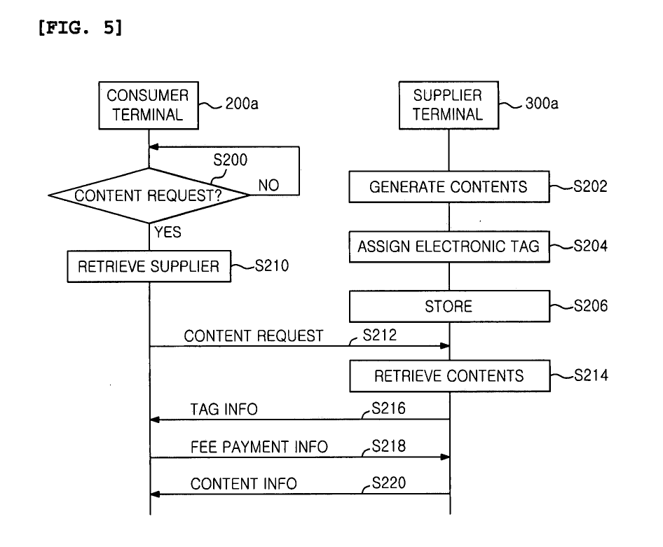

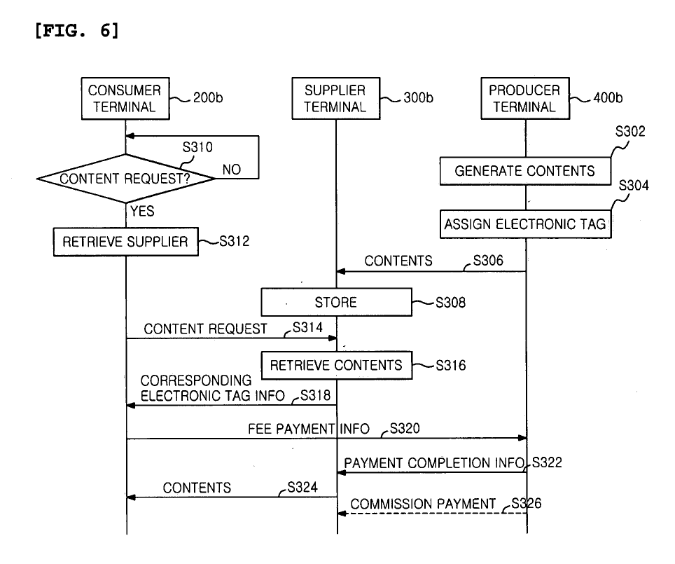

FIG. 5 is a view illustrating a procedure for providing contents in a P2P service providing system according to a first embodiment of the present invention. Referring to FIG. 5, the P2P service providing system according to the first embodiment of the present invention comprises a specific content consumer's terminal (hereinafter, referred to as “consumer terminal”) 200a and a content supplier's terminal (hereinafter, referred to as “supplier terminal”) 300a. At this time, it is preferable that the supplier terminal 300a is a terminal responsible for producing and supplying the contents.

The operation of the P2P service providing system according to the first embodiment of the present invention as described above is as follows. First, the supplier terminal 300a generates specific contents in response to a request of the content producer (S202), assigns an electronic tag to the contents (S204), and stores the contents (S206). At this time, it is preferable that the electronic tag includes producer information and fee payment information of the corresponding contents as illustrated in FIG. 4.

On the other hand, when the user requests the specific contents (S200), the consumer terminal 200a retrieves information regarding a plurality of terminals connected in the P2P system with the P2P method to retrieve a supplier for the specific contents (S210) and sends the specific content request to the supplier of the specific contents according to retrieval result (S212). At this time, it is preferable that the consumer terminal 200a transfers retrieval information (for example, a content ID) of the corresponding contents upon requesting the contents. When the supplier of the contents requested through the consumer terminal 200a is another terminal rather than the supplier terminal 300a in the retrieval result (S210), the consumer terminal 200a sends the content request to the other terminal.

Upon receiving the specific content request in step S212, the supplier terminal 300a retrieves the stored contents based on the content ID transferred along with the request (S214). Electronic tag information of the corresponding contents is extracted and transferred to the consumer terminal 200a (S216). For this, it is preferable that the supplier terminal 300a stores the unique ID for identifying the contents and the electronic tag information of the contents together when the contents are stored.

When fee payment information of the corresponding contents is received from the consumer terminal 200a (S218), the supplier terminal 300a transfers the corresponding contents to the consumer terminal 200a (S220). For this, it is preferable that the requester requesting the specific contents through the consumer terminal 200a prepays a fee to use the contents by referencing the electronic tag information of the corresponding contents and then transfers resulting information to the supplier terminal 300a through the consumer terminal 200a.

FIG. 6 is a view illustrating a procedure for providing contents in a P2P service providing system according to a second embodiment of the present invention. Referring to FIG. 6, the P2P service providing system according to the second embodiment of the present invention comprises a specific content consumer's terminal (hereinafter, referred to as “consumer terminal”) 200b, a content supplier's terminal (hereinafter, referred to as “supplier terminal”) 300b, and a content producer's terminal (hereinafter, referred to as “producer terminal”) 400b. The P2P service providing system according to the second embodiment of the present invention shows an example in which the producer and supplier of the specific contents are different from each other.

The operation of the P2P service providing system according to the second embodiment of the present invention as described above is as follows. First, the producer terminal 400b generates specific contents in response to a request of the content producer (S302), assigns an electronic tag to the contents (S304), and transfers the contents to the supplier terminal 300b (S306). At this time, the electronic tag can be assigned by the supplier terminal 300b. That is, the producer terminal 400b can directly send the contents generated in step S302 to the supplier terminal 300b, and the supplier terminal 300b can assign the electronic tag to the contents. It is preferable that the electronic tag includes producer information and fee payment information of the corresponding contents as illustrated in FIG. 4.

Then, the supplier terminal 300b stores the transferred contents (S308).

In response to the specific content request of S310 from the user, the consumer terminal 200b retrieves information regarding a plurality of terminals connected in the P2P system with the P2P method to retrieve a supplier for the specific contents (S312) and sends the specific content request to the supplier of the specific contents according to retrieval result (S314). At this time, it is preferable that the consumer terminal 200b transfers retrieval information (for example, a content ID) of the corresponding contents upon requesting the contents. When the supplier of the contents requested through the consumer terminal 200b is another terminal rather than the supplier terminal 300b in the retrieval result (S312), the consumer terminal 200b sends the content request to the other terminal.

Upon receiving the specific content request in step S314, the supplier terminal 300b retrieves the pre-stored contents based on the content ID transferred along with the request (S316). Electronic tag information of the corresponding contents is extracted and transferred to the consumer terminal 200b (S318). For this, it is preferable that the supplier terminal 300b stores the unique ID for identifying the contents and the electronic tag information of the contents together when the contents are stored.

When fee payment information of the corresponding contents is received from the producer terminal 400b (S322), the supplier terminal 300b transfers the corresponding contents to the consumer terminal 200b (S324).

For this, it is preferable that the requestor requesting the specific contents through the consumer terminal 200b prepays a fee to use the contents by referencing the electronic tag information of the corresponding contents and transfers resulting information to the producer terminal 400b through the consumer terminal 200b (S320), and the producer terminal 400b transfers fee payment completion information for the corresponding contents to the supplier terminal 300b in response to the resulting information.

It is preferable that the producer terminal 400b pays a predetermined commission for supply of the corresponding contents to the supplier terminal 300b (S326).

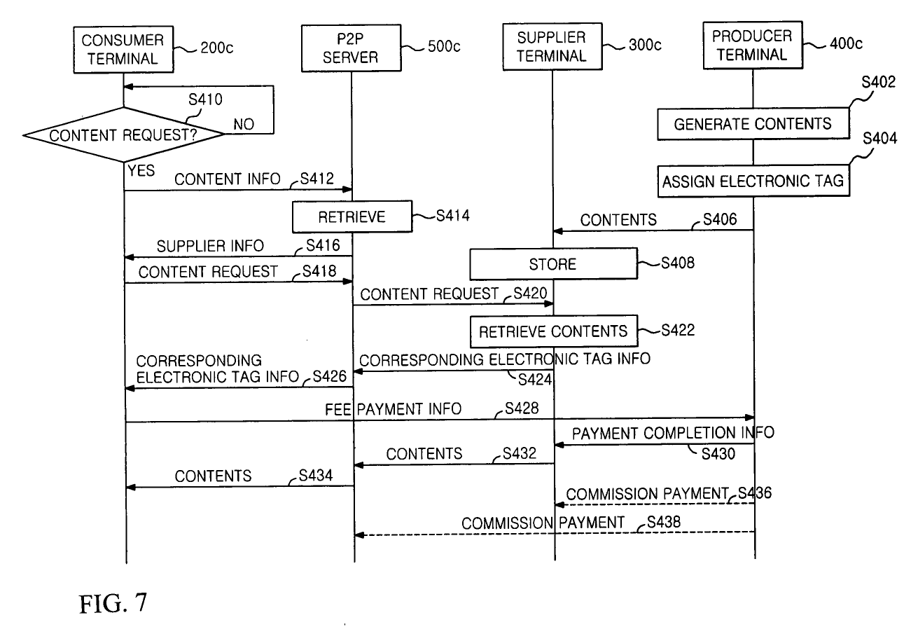

FIG. 7 is a view illustrating a procedure for providing contents in a P2P service providing system according to a third embodiment of the present invention. Referring to FIG. 7, the P2P service providing system according to the third embodiment of the present invention comprises a specific content consumer's terminal (hereinafter, referred to as “consumer terminal”) 200c, a content supplier's terminal (hereinafter, referred to as “supplier terminal”) 300c, a content producer's terminal (hereinafter, referred to as “producer terminal”) 400c, and a P2P server 500c for connecting the terminals in the P2P system with the P2P method. At this time, it is preferable that the P2P server 500c manages network information and content providing information of the terminals connected in the P2P system with the P2P method.

That is, the P2P service providing system according to the third embodiment of the present invention shows an example in which the producer and supplier of the specific contents are different from each other and the terminals using the P2P service are connected through a specific server (for example, the P2P server).

The operation of the P2P service providing system according to the third embodiment of the present invention as described above is as follows. First, the producer terminal 400c generates specific contents in response to a request of the content producer (S402), assigns an electronic tag to the contents (S404), and transfers the contents to the supplier terminal 300c (S406). At this time, the electronic tag can be assigned by the supplier terminal 300c. That is, the producer terminal 400c can directly send the contents generated in step S402 to the supplier terminal 300c, and the supplier terminal 300c can assign the electronic tag to the contents. It is preferable that the electronic tag includes producer information and fee payment information of the corresponding contents as illustrated in FIG. 4.

Then, the supplier terminal 300c stores the transferred contents (S408).

In response to the specific content request of S410 from the user, the consumer terminal 200c transfers requested content information to the P2P server 500c (S412). Accordingly, the P2P server 500c can retrieve information regarding a supplier for supplying the corresponding contents among the connected P2P terminals using the content information.

In response to the transferred content information, the P2P server 500c retrieves the information regarding the supplier for supplying the corresponding contents from the pre-stored network information and content providing information (S414) and then provides the retrieved supplier information to the consumer terminal 200c (S416).

A corresponding content request message is received from the consumer terminal 200c to which the supplier information has been provided (S418), and is transferred to the supplier terminal 300c (S420). At this time, it is preferable that the consumer terminal 200c transfers retrieval information (for example, a content ID) of the corresponding contents upon requesting the contents.

Upon receiving the specific content request in step S420, the supplier terminal 300c retrieves the pre-stored contents based on the content ID transferred along with the request (S422). Electronic tag information for the corresponding contents is extracted and transferred to the consumer terminal 200c through the P2P server 500c (S424 and S426). For this, it is preferable that the supplier terminal 300c stores the unique ID for identifying the contents and the electronic tag information of the corresponding contents together when the contents are stored.

When fee payment information of the corresponding contents is received from the producer terminal 400c (S430), the supplier terminal 300c transfers the corresponding contents to the consumer terminal 200c through the P2P server 500c (S432 and S434).

For this, it is preferable that the requestor requesting the specific contents through the consumer terminal 200c prepays a fee to use the contents by referencing the electronic tag information of the corresponding contents and transfers resulting information to the producer terminal 400c through the consumer terminal 200c (S428), and the producer terminal 400c transfers fee payment completion information for the corresponding contents to the supplier terminal 300c in response to the resulting information.

It is preferable that the producer terminal 400c pays a predetermined commission for supply of the corresponding contents to the supplier terminal 300c and the P2P server 500c (S436 and S438).

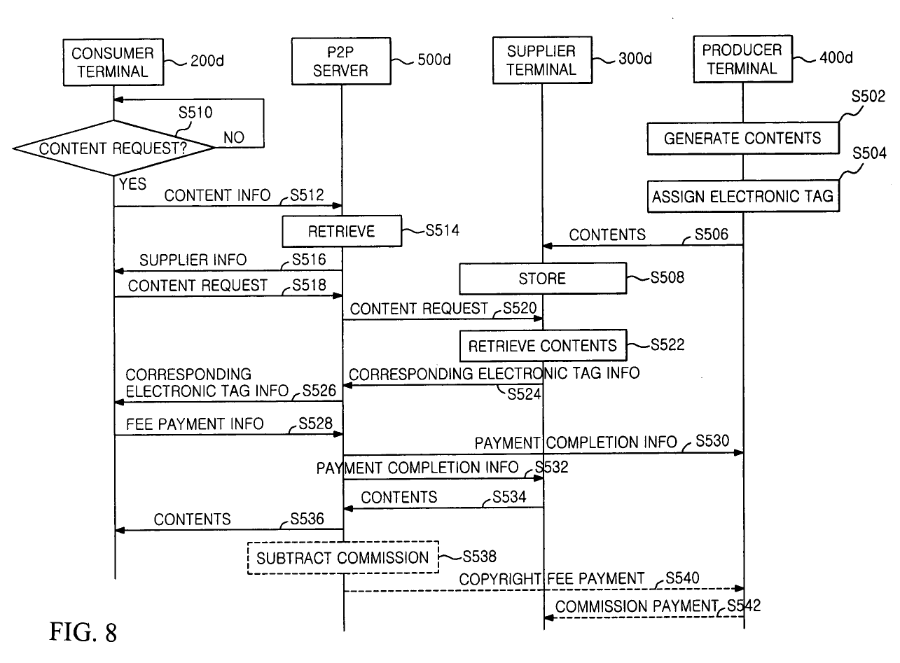

FIG. 8 is a view illustrating a procedure for providing contents in a P2P service providing system according to a fourth embodiment of the present invention. Referring to FIG. 8, the P2P service providing system according to the fourth embodiment of the present invention comprises a specific content consumer's terminal (hereinafter, referred to as “consumer terminal”) 200d, a content supplier's terminal (hereinafter, referred to as “supplier terminal”) 300d, a content producer's terminal (hereinafter, referred to as “producer terminal”) 400d, and a P2P server 500d for connecting the terminals in the P2P system with the P2P method. At this time, it is preferable that the P2P server 500d manages network information and content providing information of the terminals connected by the P2P system.

That is, the P2P service providing system according to the fourth embodiment of the present invention shows an example in which the producer and supplier of the specific contents are different from each other and the terminals using the P2P service are connected through a specific server (for example, the P2P server). The P2P service providing system according to the fourth embodiment of the present invention shows an example in which the fee to use contents is paid through the P2P server 500d.

The operation of the P2P service providing system according to the fourth embodiment of the present invention as described above is as follows. First, the producer terminal 400d generates specific contents in response to a request of the content producer (S502), assigns an electronic tag to the contents (S504), and transfers the contents to the supplier terminal 300d (S506). At this time, the electronic tag can be assigned by the supplier terminal 300d. That is, the producer terminal 400d can directly send the contents generated in step S502 to the supplier terminal 300d, and the supplier terminal 300d can assign the electronic tag to the contents. It is preferable that the electronic tag includes producer information and fee payment information of the corresponding contents as illustrated in FIG. 4.

Then, the supplier terminal 300d stores the transferred contents (S508).

In response to the specific content request of S510 from the user, the consumer terminal 200d transfers requested content information to the P2P server 500d (S512). Accordingly, the P2P server 500d can retrieve information regarding a supplier for supplying the corresponding contents among the connected P2P terminals using the content information.

In response to the transferred content information, the P2P server 500d retrieves the information regarding the supplier for supplying the corresponding contents from the pre-stored network information and content providing information (S514) and then provides the retrieved supplier information to the consumer terminal 200d (S516).

A corresponding content request message is received from the consumer terminal 200d to which the supplier information has been provided (S518), and is transferred to the supplier terminal 300d (S520). At this time, it is preferable that the consumer terminal 200d transfers retrieval information (for example, a content ID) of the corresponding contents upon requesting the contents.

Upon receiving the specific content request in step S520, the supplier terminal 300d retrieves the pre-stored contents based on the content ID transferred along with the request (S522). Electronic tag information for the corresponding contents is extracted and transferred to the consumer terminal 200d through the P2P server 500d (S524 and S526). For this, it is preferable that the supplier terminal 300d stores the unique ID for identifying the contents and the electronic tag information of the corresponding contents together when the contents are stored.

When fee payment information of the corresponding contents is received from the P2P server 500d (S532), the supplier terminal 300d transfers the corresponding contents to the consumer terminal 200d through the P2P server 500d (S534 and S536).

For this, it is preferable that the requester requesting the specific contents through the consumer terminal 200d prepays a fee to use the contents by referencing the electronic tag information of the corresponding contents and transfers resulting information to the P2P server 500d through the consumer terminal 200d (S528), and the P2P server 500d transfers fee payment completion information for the corresponding contents to the supplier terminal 300d and the producer terminal 400d in response to the resulting information (S530 and S532). At this time, the P2P server 500d can serve as an agent to pay the fee to use the contents.

On the other hand, when fee payment information is input through the consumer terminal 200d, it is preferable that the P2P server 500d subtracts a predetermined commission (S538) and pays a copyright fee to the producer terminal 400d (S540), and the producer terminal 400d pays the predetermined commission for supply of the corresponding contents to the supplier terminal 300d (S542).

The invention as described above can solve a conventional problem that a P2P system may not prevent contents from being illegally distributed upon exchanging data between individuals, by checking a right to share corresponding digital contents whenever a request for sharing the digital contents is made. Accordingly, illegal content distribution through the Internet (particularly, the P2P system) can be prevented. Therefore, the copyright of digital contents can be protected and related industries for producing and distributing the digital contents can be developed.

While the invention has been shown and described with reference to certain exemplary embodiments of the present invention, it will be understood by those skilled in the art that various changes in form and details may be made therein without departing from the spirit and scope of the present invention as defined by the appended claims and their equivalents.

What is claimed is:

1. A peer-to-peer service providing method for preventing contents from being illegally distributed, comprising the steps of:
assigning an electronic tag to digital contents after generating the contents;
providing information regarding the electronic tag in response to a content request;
determining whether a fee to share corresponding contents has been paid using the electronic tag information; and
providing the corresponding contents.

2. The peer-to-peer service providing method according to claim 1, further comprising a step of:
paying a predetermined commission from a producer to a supplier of the contents when the producer and the supplier are different.

3. The peer-to-peer service providing method according to claim 1, wherein the electronic tag includes producer information and fee payment information of the corresponding contents.

4. The peer-to-peer service providing method according to claim 3, wherein the electronic tag includes:
a unique content identifier;
content producer information;
fee information for using the contents; and
payment information for paying the fee.

5. The peer-to-peer service providing method according to claim 4, wherein the producer information includes information regarding a connection to the producer having produced the contents.

6. The peer-to-peer service providing method according to claim 4, wherein the fee information includes at least one of e-money information and point information.

7. The peer-to-peer service providing method according to claim 4, wherein the payment information includes payment account information for paying the fee.

8. A peer-to-peer service providing system for preventing contents from being illegally distributed, comprising:
a content supplier terminal for assigning electronic tags to contents on a content basis and sending corresponding contents upon determining that a fee to share the corresponding contents has been paid after sending a corresponding electronic tag when the contents are requested; and
a content consumer terminal for providing a corresponding content supplier terminal with information indicating whether the fee to share the requested contents has been paid using the electronic tag transferred from the content supplier terminal after retrieving the corresponding content supplier terminal in response to an external content request.

9. The peer-to-peer service providing system according to claim 8, wherein the electronic tag includes producer information and fee payment information of the corresponding contents.

10. The peer-to-peer service providing system according to claim 9, wherein the electronic tag includes:
a unique content identifier;
content producer information;
fee information for using the contents; and
payment information for paying the fee.

11. The peer-to-peer service providing system according to claim 10, wherein the producer information includes information regarding a connection to the producer having produced the contents.

12. The peer-to-peer service providing system according to claim 10, wherein the fee information includes at least one of e-money information and point information.

13. The peer-to-peer service providing system according to claim 10, wherein the payment information includes payment account information for paying the fee.

14. The peer-to-peer service providing system according to claim 8, further comprising:
a content producer terminal for producing contents in response to a request from a content producer,
wherein the content supplier terminal receives the generated contents from the content producer terminal and assigns an electronic tag to the contents.

15. The peer-to-peer service providing system according to claim 8, further comprising:
a content producer terminal for producing contents in response to a request from a content producer and assigning an electronic tag to the contents,
wherein the content supplier terminal receives and stores the contents to which the electronic tag is assigned from the content producer terminal.

16. The peer-to-peer service providing system according to claim 8, further comprising:
a peer-to-peer server for managing network information and content providing information regarding the content consumer terminal and content supplier terminals connected in a peer-to-peer system,
wherein the content consumer terminal and the content supplier terminals are connected through the peer-to-peer server.
